(19) United States
(12) Patent Application Publication
(10) Pub. No.: US 2012/0315473 A1
(43) Pub. Date: Dec. 13, 2012

(54) SELF-ADHESIVE CLOTH

(76) Inventor: Guey N. CHIN, Florham Park, NJ (US)

(21) Appl. No.: 13/157,495

(22) Filed: Jun. 10, 2011

(51) Int. Cl. B32B 7/12

(52) U.S. Cl. 428/343

(57) ABSTRACT

A self-adhesive cloth in one embodiment includes a main layer (10), an adhesive layer (20) disposed under the main layer (10), and an intermediate isolation layer (30) fastened between the adhesive layer (20) and the main layer (10) for preventing printing ink from permeating to the adhesive layer (20). The adhesive layer (20) is adapted to releasably adhere to an object. The self-adhesive cloth in another embodiment further includes an advertisement layer (40) formed on a top surface of the main layer (10).

### BACKGROUND OF THE INVENTION

1. Field of the Invention

The invention relates to pieces of cloth and more particularly to a self-adhesive cloth which can be released from an object adhered thereto so that the self-adhesive cloth can be reused numerous times in order to be environmentally friendly.

2. Description of Related Art

Taiwanese Utility Model Publication Number M372,695 discloses a releasable cloth device including a magnet secured to a piece of cloth by gluing, stitching, or fastening. The cloth device thus can be positioned on an iron object when not in use. In use, a user may easily remove the cloth device from the iron object and use the cloth portion thereof to wipe is out dust.

Taiwanese Utility Model Publication Number M351,060 discloses a releasable cloth device comprising a cloth unit including a piece of cloth and a magnet enclosed by the piece of cloth; and an adhesive unit including an iron member (or steel member) magnetically secured to the magnet, and an adhesive layer having one surface permanently secured to the iron member and the other surface adapted to releasably adhered to a flat surface. The cloth device thus can be positioned on an iron object by engaging the magnet therewith or positioned on a flat surface of a non-metal object by pressing the other surface of the adhesive layer against a flat surface when not in use. In use, a user may easily remove the cloth device from the iron object or the non-metal object and use the piece of cloth to wipe out dust.

However, the cloth device with magnet is not suitable to portable communication devices (e.g., mobile phones). Thus, the need for improvement still exists.

### SUMMARY OF THE INVENTION

It is therefore one object of the invention to provide a self-adhesive cloth comprising a main layer; an adhesive layer disposed under the main layer; and an intermediate isolation layer fastened between the adhesive layer and the main layer for preventing printing ink from permeating to the adhesive layer, wherein the adhesive layer is adapted to releasably adhere to an object.

Preferably, the main layer is formed of a material selected from the group consisting of recycle polyethylene terephthalate (REPET) microfiber fabric, woven cloth, non-woven fabric, and polyester fabric.

Preferably, the adhesive layer is formed of silicon rubber. Preferably, the intermediate isolation layer is formed of polyurethane (PU) or rubber.

It is another object of the invention to provide a self-adhesive cloth comprising a main layer; an advertisement layer formed on the main layer; an adhesive layer disposed under the main layer; and an intermediate isolation layer fastened between the adhesive layer and the main layer for preventing printing ink from permeating to the adhesive layer, wherein the adhesive layer is adapted to releasably adhere to an object.

Preferably, the advertisement layer comprises at least one of letters, characters, and pictures printed thereon.

Preferably, a corporate logo is printed on the advertisement layer.

Preferably, the adhesive layer acts as a suction cups.

Preferably, a user may adhere the self-adhesive cloth to a flat, non-porous surface by pressing the adhesive layer there against when not in use.

Preferably, a user may remove the adhesive layer out of the surface and use the main layer to wipe out dust and dirt accumulated on the surface.

Preferably, the adhesive layer can be released from an object which it is adhered to so that the self-adhesive cloth can be reused numerous times in order to be environmentally friendly.

The above and other objects, features and advantages of the invention will become apparent from the following detailed description taken with the accompanying drawings.

### BRIEF DESCRIPTION OF THE DRAWINGS

FIG. 1 is a longitudinal sectional view of a self-adhesive cloth according to a first preferred embodiment of the invention;

FIG. 2 is a perspective view of the rectangular self-adhesive cloth with three one corner being peeled to show three layers thereof; and

FIG. 3 is a longitudinal sectional view of a self-adhesive cloth according to a second preferred embodiment of the invention.

### DETAILED DESCRIPTION OF THE INVENTION

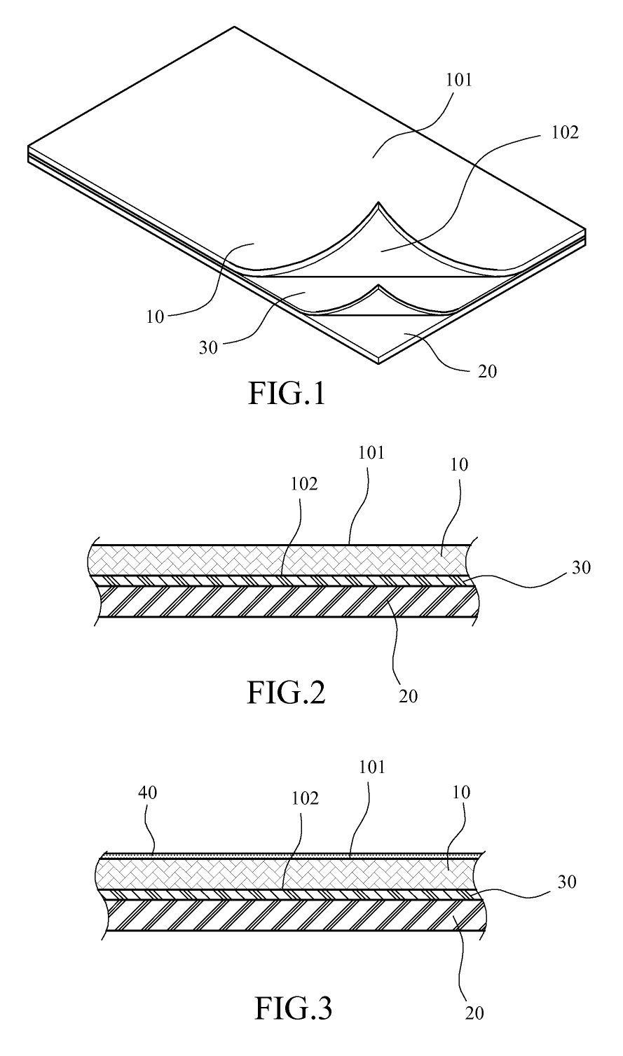

Referring to FIGS. 1 and 2, a self-adhesive cloth 1 in accordance with a first preferred embodiment of the invention comprises the following components as discussed in detail below.

A main layer 10 has a top surface 101 and a bottom surface 102. The main layer 10 is formed of recycle polyethylene terephthalate (REPET) microfiber fabric or any woven cloth having one surface of low denier between 0.01 and 1.8 and the other surface of high denier between 1.8 and 4.0, or non-woven fabric, or polyester fabric. Preferably, the woven cloth has one surface of low denier between 0.06 and 1.2 and the other surface of high denier between 2.4 and 3.6.

An adhesive layer 20 is disposed under the bottom surface 102 of the main layer 10 and formed of silicon rubber.

An intermediate isolation layer 30 is fastened between the adhesive layer 20 and the bottom surface 102 of the main layer 10. The intermediate isolation layer 30 is formed of polyurethane (PU) or rubber. The intermediate isolation layer 30 can prevent ink printed on the main layer 10 from permeating to the adhesive layer 20. Otherwise, the adhesive layer 20 may be affected its instinctive function

The adhesive layer 20 acts as a suction cups. Thus, a user may adhere the self-adhesive cloth 1 to a flat, both non-porous and porous surfaces (e.g., a flat surface of a mobile phone or its casings) by pressing the adhesive layer 20 against the surface when not in use. In use, the user may remove the adhesive layer 20 out of the surface and use the main layer 10 to wipe out dust and dirt accumulated on, for example, a liquid crystal display (LCD) of the mobile phone and its housing.

It is envisioned by the invention that the adhesive layer 20 can be released from any object which it is adhered to so as to reuse the self-adhesive cloth 1 numerous times (i.e., reusable and environmentally friendly).

Referring to FIG. 3, a self-adhesive cloth 1A in accordance with a second preferred embodiment of the invention is shown. The characteristics of the second preferred embodiment are substantially the same as that of the first preferred embodiment except the following: An advertisement layer 40 is formed on the top surface 101 of the main layer 10. The advertisement layer 40 comprises at least one of letters, characters, and pictures printed thereon. In a simplest form, a corporate logo is printed on the advertisement layer 40.

While the invention has been described in terms of preferred embodiments, those skilled in the art will recognize that the invention can be practiced with modifications within the spirit and scope of the is appended claims.

What is claimed is:

1. A self-adhesive cloth comprising:
a main layer (10);
an adhesive layer (20) disposed under the main layer (10); and
an intermediate isolation layer (30) fastened between the adhesive layer (20) and the main layer (10) for preventing printing ink from permeating to the adhesive layer (20);
wherein the adhesive layer (20) is releasable.

2. The self-adhesive cloth of claim 1, further comprising an advertisement layer (40) formed on the main layer (10).

3. The self-adhesive cloth of claim 2, wherein the advertisement layer (40) comprises at least one of letters, characters, and pictures printed thereon.

4. The self-adhesive cloth of claim 1, wherein the main layer (10) is is formed of a material selected from the group consisting of recycle polyethylene terephthalate (REPET) microfiber fabric, woven cloth, non-woven fabric, and polyester fabric.

5. The self-adhesive cloth of claim 1, wherein the adhesive layer (20) is formed of silicon rubber.

6. The self-adhesive cloth of claim 1, wherein the intermediate isolation layer (30) is formed of polyurethane (PU) or rubber.

7. The self-adhesive cloth of claim 4, wherein the woven cloth comprises one surface of low denier and the other surface of high denier.

8. The self-adhesive cloth of claim 7, wherein the low denier of one surface is between 0.01 and 1.8 and the high denier of the other surface is between 1.8 and 4.0.
